(19) United States
(12) Patent Application Publication
(10) Pub. No.: US 2007/0100668 A1
(43) Pub. Date: May 3, 2007

(54) Insurance deductible payment plans and related services

(76) Inventor: Torry C. Webb, Richland, WA (US)

Correspondence Address: WELLS ST. JOHN P.S., 601 W. FIRST AVENUE, SUITE 1300, SPOKANE, WA, 99201, US

(21) Appl. No.: 11/262,160

(22) Filed: Oct. 28, 2005

(51) Int. Cl. G06Q 40/00

(52) U.S. Cl. 705/4; 705/35

(57) ABSTRACT

A method for providing an insurance deductible payment service includes a service provider receiving contributions from a client and limiting the client's rights to the contributions to withdrawal for the purpose of paying an insurance deductible. As a result of an deductible assessed to the client, the method includes making an advance of contributions, as a loan, to pay at least a portion of the deductible. The method may include educating a client regarding financial management benefits potentially obtained by increasing a collision deductible and entering an agreement with the client to provide payment services. A method for initiating a payment service contract includes presenting to a potential client an offer of a service provider to receive one or more contributions as above. The presentation includes an offer to make an advance of contributions, as a loan, to pay at least a portion of the deductible.

### TECHNICAL FIELD

The invention pertains to insurance deductible payment plans and related services, for example, methods for providing such plans and related services and methods for initiating an insurance deductible payment plan and service contract for insured's including all forms commercial and private insurance and all types of private and/or commercial vehicles, equipment, and services.

### BACKGROUND OF THE INVENTION

Insurance coverage of various types constitutes a significant expense for many individuals and businesses. As a financial management technique, it is possible to increase or, in some cases, maximize insurance deductibles. For many types of insurance, insurance premiums decrease with increasing deductible amounts. Accordingly, savings may be realized with the lower premiums. For example, typical savings associated with raising private automobile insurance collision deductibles to $1,000 can reach 10% to 40%. In the case of commercial vehicles, the savings may be substantially more. However, many individuals and/or businesses prefer instead to avoid the risk of paying a large deductible by maintaining higher premiums. In a disciplined approach, individuals and/or businesses can establish a sufficient amount of savings to cover elevated deductibles in the event that an insurance claim becomes necessary. However, the discipline needed to establish and maintain sufficient savings regardless of other monetary demands evades many. Accordingly, only some find themselves in the circumstances allowing low risk realization of the premium savings associated with high deductible insurance policies. At least for such reasons, it would be an improvement to provide a service enabling more people or businesses to take advantage of high deductibles.

### SUMMARY OF THE INVENTION

In one aspect of the invention, a method for providing an insurance deductible payment plan and related services includes a service provider receiving one or more contributions from a client and limiting the client's rights to the contributions to withdrawal for the purpose of paying a specified insurance deductible. As a result of an insurance deductible assessed to the client by an insurance carrier, the method includes making an advance of contributions, as a loan, to pay at least a portion of the insurance deductible.

In another aspect of the invention, a method for providing an insurance deductible payment plan and related services includes educating a client regarding financial management benefits potentially obtained by increasing an automobile insurance collision deductible and entering a written, mutual agreement with the client to provide an insurance deductible payment plan and related services. The agreement includes a promise to receive one or more monthly contributions from a client whose rights to the contributions are limited under the agreement to withdrawal for the purpose of paying the collision deductible. The agreement also includes a promise to make an advance of contributions, as a 0% interest loan, to pay at least a portion of the collision deductible when assessed to the client by an insurance carrier.

In a further aspect of the invention, a method for initiating a contract for an insurance deductible payment plan and related services includes presenting to a potential client an offer of a service provider to receive one or more contributions from a client whose rights to the contributions are limited in a contract to withdrawal for the purpose of paying an insurance deductible. The presentation includes an offer to make an advance of contributions, as a loan, to pay at least a portion of the insurance deductible when assessed to the client by an insurance carrier.

### DETAILED DESCRIPTION OF THE PREFERRED EMBODIMENTS

In the context of the present document, a “deductible” refers to an amount specified in an insurance policy that relieves the insurer of responsibility for an initial specified loss of the kind insured against. Depending upon the type of insurance and other circumstances, a “deductible” may be referred to as a copayment or some other term. One possibility for assisting people and businesses in obtaining the advantages of high deductible insurance policies includes providing insurance deductible payment plans and related services. Potentially, such plans and related services could meet one or more of the following objectives for clients: cover insurance deductibles, increase cash flow, improve personal savings program, enhance financial position, and manage personal resources more efficiently. A service contract between a service provider and a client, private or commercial, may be used to allow the client to pay a lower insurance premium while assuring their capability to meet a higher deductible.

According to one aspect of the invention, a method for providing an insurance deductible payment plan and related services includes a service provider receiving one or more contributions from a client and limiting the client's rights to the contributions to withdrawal for the purpose of paying an insurance deductible. As a result of an insurance deductible assessed to the client by an insurance carrier, the method includes making an advance of contributions, as a loan, to pay at least a portion of the insurance deductible. By way of example, the insurance deductible may be an automobile insurance collision deductible. Research indicates that, in comparison to collision coverage, premiums for other types of automobile insurance coverage, e.g. comprehensive coverage, are affected less dramatically by raising or lowering deductibles. However, the aspects of the inventions described herein are not limited to collision deductibles or even automobile insurance deductibles generally. Medical and homeowner's insurance coverage, as well as all other types of insurance, private and commercial, potentially present additional opportunities for applying the aspects of the inventions.

Also, for example, the service provider is not necessarily an insurance carrier. In fact, significant advantages may be realized when the service provider is not an insurance carrier. Aspects of the invention may be arranged so as to operate outside the realm of insurance and/or securities regulation. The most advantageous arrangement may be characterized as financial resource management programs that operate in the realm of service contracts. Personal financial resource management appears to provide the most opportunity for applying the aspects of the inventions, however, there are many viable commercial applications for applying all aspects of the inventions. Without insurance and/or securities regulation, an insurance deductible payment service may operate with greater efficiency and flexibility, reducing the cost of doing business. Such circumstance translates into improved profitability for the service provider and lower fees for private and commercial clients.

An insurance deductible payment service offers additional advantages to at least three distinct entities. As described herein, the client may increase cash flow and savings, as well as obtaining other benefits. The service provider may generate income by investing contributions made by clients, ultimately realizing a profit after the expenses of operating the service. The insurance carrier also benefits from an insurance deductible payment service. With the increased prevalence of insured parties opting for higher deductibles, the insurance carrier's loss ratio may improve. As known to those of ordinary skill, loss ratio is typically the ratio of incurred losses and loss-adjustment expenses to a net earned premium. Loss ratio measures an insurance carrier's underlying claims results, or loss experience, on its overall business. Loss ratio may be used along with other factors to reflect the overall profitability of the insurance carrier's underwriting.

That is, satisfying an insurance claim results in a loss to the insurance carrier. If the deductible is high, then the insurance carrier experiences less loss in satisfying the claim in comparison to the loss associated with a lower deductible. Accordingly, an insurance deductible payment service may be arranged to benefit the clients and service provider as well as insurance carriers.

The method for providing an insurance deductible payment plan and related services may further include limiting the client's rights to the contributions to exclude trustor and trust beneficiary rights. Limiting the client's rights in this manner avoids the limitations and restrictions that might arise if the service provider is considered a trustee, holding the client's contributions in trust for later withdrawal. Since the benefits to the service provider result at least in part from investing the client's contributions, the method may include obtaining the client's authorization to use the contributions to acquire and retain every kind of property and investment. Similarly, the method may include obtaining the client's agreement that no obligation exists to pay the client any interest on the contributions. Further, the method may include obtaining the client's agreement that no obligations exists to pay to or apply for the benefit of the client any gross or net income generated by investment of the contributions. Authorizations and agreements such as described or in like manner clarify the respective rights and roles of the service provider and client.

Making, paying, and advancing contributions may be arranged in a variety of ways. The Table in the Example below summarizes only a few of the possible ways. As a financial resource management program, it appears most beneficial to clients that their contributions be monthly, although other arrangements are conceivable. Monthly contributions teach the principal of making regular and consistent efforts to secure one's financial well-being.

In the event of an insurance deductible being assessed to the client, the service provider may provide an advance of contributions to pay the entire insurance deductible. Paying the entire deductible with an advance is generally more beneficial to the service provider than the alternative of the client withdrawing accumulated contributions and obtaining an advance of contributions to pay a remaining portion of the deductible. Since clients are required to continue making contributions until their account is mature, and are also generally required to repay any advance(s) of contributions, there is typically no disadvantage to the client in this manner of operation.

As a further benefit to the client, the method may include not accruing interest on the loan arising from the advance of contributions. As is apparent, it thus remains advantageous for clients if an advance of contributions is required to pay a portion of or the entire insurance deductible. As another benefit to the client, the method may include not assessing fees or loan interest to the client as long as the client continues any required contributions and any required repayment of advanced contributions.

One example of a possible fee includes a management fee, which might be referred to or defined as a “deferred” management fee, assessed to the client upon termination of the service. The amount of the management fee may decrease with increasing length of service or remain constant over a specified period of time or the life of the account. Accordingly, the management fee may be less for clients that use the service for a longer period of time. For long term clients, the management fee may be reduced to zero. The contributions may occur during a service duration agreed to by the client. The method may further include disbursing contributions after obtaining a client's confirmation of continuing the service for the remaining duration. If a client elects not to confirm continuing the service, then any applicable fees can be deducted prior to disbursing contributions, saving the effort of collecting fees after diminishing the account balance.

Also, allowance may be made for exceptional circumstances. Thus, the management fee may be reduced to zero for termination due to exceptional circumstances, such as, without limitation, loss of a driver's license due to medical and/or health reasons, disability, illness, etc.

As may be appreciated from the various possibilities discussed herein, an insurance deductible payment service may be arranged such that a client accumulates contributions for paying an entire insurance deductible in a timely manner. In the meantime, any insurance deductibles assessed may be paid entirely by an advance of contributions. Provided the client continues any required contributions and any required repayment of advanced contributions, the client might not incur fees or loan interest. Long term clients may ultimately improve their financial condition and then terminate the service, but still not incur a management fee, typically deducted from their accumulated contributions.

It is a significant advantage that clients who demonstrate discipline in accumulating contributions, repaying advanced contributions, and maintaining the service for an extended period may obtain the provided services at little or no expense. All of the accumulated contributions of long term clients may be returned if not used. These features and advantages, along with others, potentially make the payment service very attractive to potential clients. The ability of a service provider to assist clients in such manner arises at least in part from characterization as a service contract instead of insurance and/or securities. Exclusion of trustor and trust beneficiary rights also helps. Otherwise freeing the service provider to acquire and retain every kind of property and investment without obligation to the client regarding interest, gross income, or net income, along with other aspects of the inventions described herein, further helps.

Additional advantages of an insurance deductible payment plan and related services include the ease with which such a service may be implemented and continued. That is, immediate coverage for a client's collision insurance deductible may begin without requiring an initial payment. An agreement for continuing the service and early termination fee may be structured so as to motivate continued use of the service, even if a deductible is assessed prior to accumulating a significant amount of contributions. Also, the payment service may operate independent of insurance carriers so that clients may change carriers without affecting the payment service.

Also, the payment service may be arranged to stay with a client regardless of vehicle ownership. Buying or selling a particular vehicle need not affect the payment service. The agreement may allow the payment service to cover a client, co-client, and all direct dependents along with all vehicles owned by the covered parties. In a commercial aspect, using, for example, collision deductibles, the payment plan and service may be used to cover a single vehicle or fleet and all authorized drivers. In the event that the number of covered parties and/or vehicles is large, the client(s) may elect to open one or more additional insurance deductible payment plan accounts so as to provide additional coverage in the event of multiple deductibles. Additional accounts may be opened at any time, such as when a dependent or employee becomes a new driver or a new vehicle is purchased. Other types of analogous arrangements can be implemented for applying aspects of the inventions to all other types of property, casualty, liability and surplus lines of insurance.

The payment service may be arranged to be flexible in allowing clients to increase contributions at any time, reaching accumulation goals more quickly. Similarly, an advance of contributions may be repaid at a minimum amount, for example, $25 per month, or repayment may be accelerated according to a client's desire. However, it is advantageous that repayment occurs in addition to any contribution requirements. Again, stressing consistent efforts to ensure one's financial well-being, regardless of mishap. Automatic and/or electronic debit of designated checking and/or savings accounts held by a client, or any other form of automated billing and/or collection processes effectively reduces labor requirements and processing costs and improves payment consistency.

As a measure to avoid potential deception and fraud by clients, the method may include paying advanced contributions only to an automobile service center. Further, the method may include making no exception for collision repairs not reported in a claim to the insurance carrier. That is, a relatively common practice among insured parties includes paying for collision repairs themselves without reporting a claim to the insurance carrier. Even though such practice may attempt to avoid insurance premium increases, verification of deductible authenticity may be enhanced in the aspects of the inventions by making no exception for collision repairs not reported in a claim to the insurance carrier. Clients resorting to paying for repairs themselves would thus not necessarily be able to rely upon their accumulated contributions in an insurance deductible payment service.

In another aspect of the invention, a method for providing an insurance deductible payment plan and related services includes educating a client regarding financial management benefits potentially obtained by increasing an automobile insurance collision deductible and entering a written, mutual agreement with the client to provide insurance deductible payment plans and related services. The agreement includes a promise to receive one or more monthly contributions from a client whose rights to the contributions are limited under the agreement to withdrawal for the purpose of paying the collision deductible. The agreement also includes a promise to make an advance of contributions, as a 0% interest loan, to pay at least a portion of the collision deductible when assessed to the client by an insurance carrier. By way of example, the method may further include investing the contributions. Also, the mutual agreement may be written so as to contain and/or implement the various features associated with other aspects of the inventions described herein.

In a further aspect of the invention, a method for initiating a contract for an insurance deductible payment plan and related services includes presenting to a potential client an offer of a service provider to receive one or more contributions from a client whose rights to the contributions are limited in a contract to withdrawal for the purpose of paying an insurance deductible. The presentation includes an offer to make an advance of contributions, as a loan, to pay at least a portion of the insurance deductible when assessed to the client by an insurance carrier. By way of example, presentation of the offer may be performed by an independent agent of the service provider. The offer and/or contract may be arranged so as to contain and/or implement the various features associated with other aspects of the inventions described herein. Accordingly, the contract may state that no interest accrues on the loan unless the client defaults. Also, the contract may state that its duration continues until the contract is terminated.

One example of combining the various features of aspects of the invention described herein is provided below. The example represents but one of many possible combinations of features and also includes additional features not otherwise described herein. Such additional features may be incorporated into other aspects of the inventions described herein.

### EXAMPLE

Selected details of an exemplary Administrative Services and Management Contract for collision insurance are described below.

SERVICES PROVIDED: Client has chosen to participate in the Service Plan for their automobile collision insurance only and agrees to the following terms and conditions as set forth below. The purpose of the Service Plan is to provide a, disciplined approach to the management and more efficient use of financial resources. The Service Plan is designed to ensure that the client can meet his or her collision deductible for the first collision following enrollment in the Service Plan. Pursuant to the Contract, Company agrees to provide Client with the following services:

(1) Administrative Services: Company will automatically and electronically debit Client's designated checking or savings account for the required monthly plan contributions (“Contributions”) and/or any additional required Contributions in accordance with Client's Monthly Contribution Plan (“Plan”) selected by Client at the time of application.

(2) Records: Company will keep a record of all Client Contributions received from Client. Authorized agents will keep copies of all pages of new account applications for a minimum of four years.

(3) Disbursement Services: During Client's participation in the Service Plan, Company may disburse Client's Contributions to authorized service centers, designated by Company, Client or Client's insurance company as required. (See “Withdrawal and Use of Contributions” below.)

(4) Loan Services: Company agrees to provide Client with one or more zero interest loans (“Advances”) PROVIDED that the total amount of any and all Advances do not exceed the applicable Service Plan Advance Limits at any given time; notwithstanding applicable advance limits and credit policies. All Advances shall be provided in accordance with the conditions and provisions hereinafter set forth and the Company's Service Plan Advance Request and Disbursement Policy. (See also “Advance of Contributions” below.)

MONTHLY CONTRIBUTIONS: Client agrees to make monthly Contributions in accordance with the Plan. Contributions shall be deemed “prepayments” on Advances that “may” or “may not” be requested by Client under the terms set forth in “Withdrawal and Use of Contributions” and/or “Advance of Contributions,” below.

(1) Contribution Schedule: Contributions will begin in the month immediately following the month of application, provided that said Application was received and processed on or before the last day of the month received. Contributions will continue until the Client has contributed the Plan Target Amount (“Target”) required by the Plan selected, at which time Contributions will stop.

(2) Failure to Make Monthly Contributions: Failure to make Contributions in accordance with the chosen Plan may result in termination of Client's Service Plan. Upon such termination, Client shall be responsible for any and all fees, charges and expenses due, as described and set forth herein.

(3) Additional Contributions: In order to more rapidly increase the Client's withdrawal and/or borrowing capacity in accordance with the Service Plan, Clients may increase their Plan and/or Advance Repayments at any time, but at no time may Clients contribute less than the Plan amount indicated on the Service Plan New Account Application or the minimum Advance payment requirement as applicable.

Management and Disposition of Contributions:

(1) Deposit of Contributions: Client Contributions may initially be deposited by Company in an account maintained by a state or federally chartered bank. Client shall have no rights to the Contributions except as stated herein.

(2) Management of Funds: Upon deposit of Contributions, Company is authorized to use said Contributions to acquire and retain, for Company's own account, every kind of property, real, personal, or mixed, and every kind of investment specifically including but not by way of limitation, debentures and other corporate obligations, and stocks (preferred or common) in the sole discretion of Company.

(3) Obligation to Pay: Company is not obligated to pay to or apply for the benefit of Client, at any time, any portion of the gross or net income received by Company from the investment of Contributions held by Company; and the Client further expressly agrees and understands that Company shall have no obligation to pay Client any interest on Client's Contributions while held at any time during or: after the contribution phase of Client's Plan.

### WITHDRAWAL AND USE OF CONTRIBUTIONS:

(1) Use of Contributions: Client acknowledges that, subject to the terms and conditions hereof, Client may request the withdrawal of the Contributions ONLY for the purpose of paying Client's authorized and bona-fide collision insurance deductible.

(2) Request for Funds: A Request for Funds is a “withdrawal” request made by a Client, for any amount, from the Client's Service Plan Account. If available Contributions are not sufficient to pay Client's required collision insurance deductible, Client “may” request an Advance in accordance with the terms and provisions set forth below in Advance of Contributions. Clients shall file a Request for Funds ONLY after filing a formal collision (or “loss”) claim with Client's insurance carrier. A copy of the completed insurance claim, in addition to any other documents required by the Company prior to processing any Request for Funds, will be submitted prior to the disbursement of any requested funds and/or Advance proceeds. A Request for Funds, partial or full, shall never exceed the balance of the Client's Account. Requests shall include, but not be limited to, an acknowledgement that Client agrees to continue to maintain a Service Plan Account in accordance with Client's original Contribution Plan. (See “Continuation of Account” below.) The documents required, when filing a Request for Funds, are listed below in “Verification of Requests for Funds.”

(3) Continuation of Account: At the time of any Request for Funds, Client shall be required to confirm their intention to continue their Service Plan represented by this Contract. If Client elects to terminate their Service Plan, at the time, the applicable Contingent Deferred Management Fee (“Management Fee”), if any, “may” be charged as set forth herein. Should the available Account balance be insufficient to pay the applicable Management Fee, the outstanding balance shall be invoiced directly to Client, due and payable upon receipt, as set forth in the Termination of Contract provisions below. The Management Fee, if applicable, shall be deducted from the existing balance of Client's Account, prior to disbursement of Account proceeds. Notwithstanding termination of Client's Service Plan, Client may request an Advance in accordance with the provisions set forth below in “Advance of Contributions.”

(4) Verification of Requests for Funds: Upon submission of an authorized Request for Funds, Client agrees to provide the Company with the following: (a) A copy of the current and completed (open or closed) insurance claim filed by Client and signed by Client's insurance agent or authorized insurance company representative; (b) an Affidavit of Inspection and Verification (to be completed by the licensed and/or bonded authorized service provider which will be performing repairs as authorized by Client's insurance carrier); and (c) any additional documents deemed necessary by Company that may be required by Company to determine the validity of Client's Request for Funds, the status thereof, or the authorized payee. Request for Funds will not be processed, nor shall funds be disbursed, until Company has received all requested documents.

(5) Disbursement upon Approval: Upon Company's approval of Client's Request for Funds (and all applicable loan documents in the case of an Advance of Contributions), Company shall disburse the requested funds (minus any applicable Management Fee) to the appropriate party.

ADVANCE OF CONTRIBUTIONS: In the event Client does not have sufficient Contributions in their Service Plan Account(s), available for the purpose of paying Client's required automobile insurance collision deductible(s) in full, as determined by the Service Plan Request for Funds, the requested funds will be advanced in full to Client from the Company, provided Client's account is in good standing. Client may request an Advance for any amount (i.e. $100, $250, $500, etc.) up to the maximum amount authorized by the Plan chosen and the Service Plan Advance Request and Disbursement Policy; however, at no time shall any single Advance be greater than $1,000 (or $2,000 for a Series 2000 Plan). Company agrees to provide Advances, at the request of Client, in accordance with the following terms and conditions:

(1) Advance Conditions: (a) All Client Service Plan Accounts are current and in good standing; and (b) Supporting Documents: Copies of the applicable insurance claim, in addition to any other documents requested by Company, have been properly submitted, reviewed and approved by Company.

(2) Advance Limit: Notwithstanding the Company's Service Plan Advance Request and Disbursement Policy, the Advance request shall not cause the total of all outstanding Advances to exceed a maximum of $1,000 (or $2,000 for a Series 2000 Plan).

(3) Limitation of Advances and Plan Benefits: Should Client have the maximum amount of $1,000 outstanding (or $2,000 for a Series 2000 Plan), funds available to cover additional collision deductibles shall be limited ONLY to the amount of Plan Contributions available in Client's Account which may or may not be sufficient to cover “additional” collision deductibles. Example: Assume that a client has accumulated twenty Contributions over twenty months ($25×20) and has an account balance of $500 in their Service Plan Account. At that time, the client is involved in a collision requiring a $1,000 collision deductible payment or copayment. The client may file a Request for Funds for $1,000, which will be provided in the form of an Advance in the amount of $1,000 (as client's Account balance is only $500 and not sufficient to cover the “total” request). The $1,000 Advance would then be used, by the client, to pay the authorized collision deductible of the same amount. At that time, the client would have $1,000 of the maximum available advance limit of $1,000 outstanding. The maximum amount that would be immediately available to the client (in the event of a second collision) would be the account balance of $500 which may be requested to cover a second collision deductible, by completion of a Request for Funds, in addition to any other required documents. Had the Client's Service Plan Account been mature (with $1,000) in this example, a full $1,000 would be available for a second collision. If Client wishes to guarantee availability of an additional $1,000 (or $2,000 for a Series 2000 Plan), available in the form of an Advance, the Client must open a second Service Plan with Company. There is no limit to the number of Accounts that a client may open, provided that all Accounts are active and in good standing.

(4) Written Request Required: All Advance requests shall be in writing on an approved Company form.

(5) Promissory Note and Repayment Agreement: In addition to the Request for Funds, Client shall, prior to the approval of any Advance request and disbursement of funds, submit a completed and signed Promissory Note and Advance Repayment Agreement (“Note”) providing for repayment of the Advance at zero percent (0.00%) interest per annum, at monthly payments of not less than $25.00 per month. Client understands that any and all Advance repayments will be repaid in monthly installments of not less than $25.00 per month, IN ADDITION TO any Contributions due in accordance with the selected Contribution Plan and current Service Plan Contract(s).

(6) Interest Rate Adjustment: Should Client terminate any Account(s), or should any Account(s) and/or Advance repayment(s) be more than 30 days outstanding, the Account(s) and/or Advance(s) shall be deemed “in default” and the applicable interest rate (“Rate”) on the balance of any outstanding Advance(s) as of the date of default may be imposed by the Company. Said Rate shall be not more than 10.000% per annum. Client's monthly payment under the Note may be increased to reflect any interest accrued (from the date of the default) on the outstanding principal balance.

(7) Default: Failure to repay any Advance in accordance with the signed Note may result in an acceleration of the payment of the outstanding balance of the Advance and the termination of Client's Account. Client agrees that, at that time, the accelerated balance will be deducted from any previous Contributions made by Client whether under this Contract or any other Service Plan Account which Client may have with the Company.

(8) Effect of Termination: Upon termination of Client's Account(s), Client shall be invoiced for all applicable fees; charges and expenses associated with said termination(s), as described and set forth herein (see “Fees, Charges, Expenses, and Deductions” below).

FEES, CHARGES, EXPENSES AND DEDUCTIONS: By execution of this Contract, or any attachment, document or addendum incorporated by reference, Client agrees to pay the following fees, charges, expenses and deductions:

(1) Contingent Deferred Management Fee (“Management Fee”): For all services provided to Client by Company (excluding miscellaneous fees and charges referenced in section (3) below), Client agrees to pay to Company a Management Fee. This fee is payable in minimum installments of $25 per month. The monthly installments shall be deferred while Client's Account is in good standing and this Contract remains in effect. If this Contract is terminated for any reason, the Management Fee will be due and payable in full and upon demand, to Company, according to the following schedule: (a) Month 1 through Month 60 (Years 1-5): $325; (b) Months 61 through 120 (Years 6-10): $200; (c) Months 121-180 (Years 11-15): $100; (d) Thereafter through the life of the Account: $0.00. The Management Fee shall be deducted from any Contributions due Client less any additional fees and charges due Company at the time of termination of Client's Account(s).

(2) Processing Fee (“Processing Fee”): All accounts cancelled or terminated for cause, whether voluntarily or involuntarily, or terminated by Client for Legal Termination (see “Legal Termination” below), shall be subject to a $25 Processing Fee.

(3) Insufficient Contributions: In the event Client does not have sufficient Contributions in said Account at time of termination, Company shall invoice Client for all fees and charges due. Client hereby agrees to pay Company the balance due, in full, on receipt of said invoice. If payment is not made within ten days of receipt of said invoice, any and all outstanding balance shall accrue interest at an amount not to exceed 10.000% per annum.

(4) Miscellaneous Fees and Charges: Client hereby agrees to pay the following miscellaneous fees and charges: (a) All fees generated by or at the request of Client, associated with Bank Checks, Cashier's Checks, payments, distributions, refunds, wire fees, transfer fees or any other form of payment to Client for any reason other than “normal and routine” operations; (b) All fees generated by or at the request of Client, associated with copies, filing, billing and all other administrative charges incurred for actions not originating from the “normal and routine” course of operations (such fees shall be charged pursuant to Company's then-current rate card, a copy of which is available upon request, and which may be amended from time to time by the Company at its discretion, without notice to Client), and (c) If any Contribution is 10 or more days late, Client “may” be charged 5% of the unpaid portion of the regularly scheduled payments or $10, whichever is greater.

TERMINATION OF CONTRACT: Company and Client agree this Contract may be terminated in accordance with the terms and provisions set forth below.

(1) Right to Terminate: Company reserves the right to terminate Client's Account(s) for failure to perform obligations under this Contract or under any Note. Such notice of termination shall be delivered by first class regular mail, postage prepaid. Such termination “may” obligate Client to certain fees, charges, expenses and deductions as described and set forth herein. (See “Fees, Charges, Expenses, and Deductions” above).

(2) Authorized Persons: Client or Client's legal and appointed representative may, for any reason, terminate Client's Account(s) at any time. Such termination “may” obligate Client to certain fees, charges, expenses and deductions as described and set forth herein. (See “Fees, Charges, Expenses, and Deductions” above).

(3) Request for Termination: Voluntary requests for termination under Section (2) above shall be submitted on a Company approved form or by submitting, in writing and thirty days prior to the next scheduled Contribution if applicable, a written notice requesting termination of Client's Account(s) and payment of Account Contributions.

(4) Account Termination: Upon receipt of written notification from Client requesting that Company terminate said Account(s), Company shall immediately close Client's Account(s).

(5) Legal Termination: Service Plan Client(s) and their duly authorized representatives may “legally terminate” their account for exceptional circumstances (i.e. loss of driver's license due to medical and or health reasons, disability, illness, etc.) without incurring any Deferred Management Fee. Such terminations shall be subject to the $25 Processing Fee as set forth herein.

(6) Refund of Contributions: Within thirty (30) days of termination, voluntary or involuntary, Company will return Client's Contributions, less any fees, charges, expenses and deductions due Company.

(7) Fees and Charges: Upon any termination (by Company or by Client), Client will be liable for all applicable fees and charges identified above in “Fees, Charges, Expenses and Deductions.” No termination shall affect Client's obligation to repay any outstanding Note(s).

TERM OF CONTRACT: This Contract shall commence upon expiration of Client's mandatory three day right to cancel and, notwithstanding a properly executed Conditional Receipt, shall be effective on the date that Company first receives Client's initial contribution (the “Effective Date”) as described above in Monthly Contributions and shall continue until terminated in accordance with the provisions set forth herein.

ADVANCE REQUEST AND DISBURSEMENT POLICY: The purpose of the Service Plan Advance Request and Disbursement Policy is to clarify the position of Company regarding the ability of Client to request and obtain an Advance in accordance with the provisions set forth in the Administrative Services and Management Contract. Client has a variety of plans to choose from and the plan chosen dictates the total amount of interest free Advances the client will be eligible to receive.

Maximum Advance Limits: The following Table illustrates the available Contribution Plans, the Plan Target Amount, and the maximum amount of interest free advances for which the plan participant will be eligible to have outstanding at any given time:

TABLE

| | | |
|---|---|---|
| Monthly | | Maximum |
| Contribution | Plan Target | Advance |

Contribution Plan 1000 Series

| | | | |
|---|---|---|---|
| Plan A (8 Months) | $100.00 | $800.00 | $1,200.00 |
| Plan B (12 Months) | $75.00 | $900.00 | $1,100.00 |
| Plan C (20 Months) | $50.00 | $1,000.00 | $1,000.00 |
| Plan D (40 Months) | $25.00 | $1,000.00 | $1,000.00 |

Contribution Plan 2000 Series

| | | | |
|---|---|---|---|
| Plan A (8 Months) | $200.00 | $1,600.00 | $2,400.00 |
| Plan B (12 Months) | $150.00 | $1,800.00 | $2,200.00 |
| Plan C (20 Months) | $100.00 | $2,000.00 | $2,000.00 |
| Plan D (40 Months) | $50.00 | $2,000.00 | $2,000.00 |

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications, including for private or commercial application, within the proper scope of the appended claims appropriately interpreted in accordance with the doctrine of equivalents.

1. A method for providing an insurance deductible payment plan and related services comprising a service provider:
receiving one or more contributions from a client and limiting the client's rights to the contributions to withdrawal for the purpose of paying a specified insurance deductible; and
as a result of an insurance deductible assessed to the client by an insurance carrier, making an advance of contributions, as a loan, to pay at least a portion of the insurance deductible.

2. The method of claim 1 wherein the insurance deductible is an automobile insurance collision deductible.

3. The method of claim 1 wherein the service provider is not an insurance carrier.

4. The method of claim 1 wherein the contributions are monthly contributions.

5. The method of claim 1 further comprising limiting the client's rights to the contributions to exclude trustor and trust beneficiary rights.

6. The method of claim 1 further comprising obtaining the client's authorization to use the contributions to acquire and retain every kind of property and investment.

7. The method of claim 1 further comprising obtaining the client's agreement that no obligation exists to pay the client any interest on the contributions.

8. The method of claim 1 further comprising obtaining the client's agreement that no obligation exists to pay to or apply for the benefit of the client any gross or net income generated by investment of the contributions.

9. The method of claim 1 wherein advances are made only to an automobile service center with no exception being made for collision repairs not reported in a claim to the insurance carrier.

10. The method of claim 1 wherein the contributions occur during a service duration agreed to by the client and the method further comprises disbursing contributions after obtaining client's confirmation of continuing the service for the remaining duration.

11. The method of claim 1 further comprising not accruing interest on the loan.

12. The method of claim 1 further comprising not assessing fees or loan interest to the client as long as the client continues any required contributions and any required repayment of advanced contributions.

13. The method of claim 1 wherein the advance pays the entire insurance deductible.

14. The method of claim 1 further comprising, upon termination of the service, assessing to the client a management fee the amount of which decreases with increasing length of service.

15. The method of claim 14 further comprising reducing the management fee to zero for termination due to exceptional circumstances.

16. A method for providing an insurance deductible payment plan and related services comprising a service provider:
receiving one or more monthly contributions from a client and limiting the client's rights to the contributions to withdrawal for the purpose of paying an automobile insurance collision deductible;
limiting the client's rights to the contributions to exclude trustor and trust beneficiary rights;
obtaining the client's authorization to use the contributions to acquire and retain every kind of property and investment;
obtaining the client's agreement that no obligation exists to pay the client any interest on the contributions;
obtaining the client's agreement that no obligation exists to pay to or apply for the benefit of the client any gross or net income generated by investment of the contributions;
as a result of an insurance deductible assessed to the client by an insurance carrier, making an advance of contributions, as a loan, to pay the entire insurance deductible, the advance being made only to an automobile service center with no exception being made for collision repairs not reported in a claim to the insurance carrier;
not assessing fees or loan interest to the client as long as the client continues any required contributions and any required repayment of advanced contributions; and
upon termination of the service, assessing to the client a management fee the amount of which decreases with increasing length of service.

17. A method for providing an insurance deductible payment plan and related services comprising:
educating a client regarding financial management benefits potentially obtained by increasing an automobile insurance collision deductible; and
entering a written, mutual agreement with the client to provide an insurance deductible payment plan and related services, the agreement including:
a promise to receive one or more monthly contributions from a client whose rights to the contributions are limited under the agreement to withdrawal for the purpose of paying the collision deductible; and
a promise to make an advance of contributions, as a 0% interest loan, to pay at least a portion of the collision deductible when assessed to the client by an insurance carrier.

18-26. (canceled)

27. A method for initiating a contract for an insurance deductible payment plan and related services comprising presenting to a potential client an offer of a service provider to:
receive one or more contributions from a client whose rights to the contributions are limited in a contract to withdrawal for the purpose of paying an insurance deductible; and
make an advance of contributions, as a loan, to pay at least a portion of the insurance deductible when assessed to the client by an insurance carrier.

28. The method of claim 27 wherein presenting the offer is performed by an independent agent of the service provider.

29-38. (canceled)

39. The method of claim 27 wherein the contract states a duration of continuing until termination.

40. (canceled)
